(19) United States
(12) Patent Application Publication
(10) Pub. No.: US 2026/0142833 A1
(43) Pub. Date: May 21, 2026

(54) PROBABILISTIC SIGNATURE CREATION FOR DATA FILES

(71) Applicant: Lenovo (Beijing) Limited, Beijing (CN)

(72) Inventors: Christian De Hoyos, Morrisville, NC (US); Jason Grimme, Cary, NC (US); Igor Stolbikov, Apex, NC (US); Chunling Han, Changping District, Beijing (CN); Scott Li, Cary, NC (US)

(21) Appl. No.: 19/119,377

(22) PCT Filed: Nov. 23, 2022
(86) PCT No.: PCT/CN2022/133698

§ 371 Date: Apr. 8, 2025

(51) Int. Cl. H04L 9/32; H04L 9/14

(52) U.S. Cl. CPC H04L 9/3247; H04L 9/14

(57) ABSTRACT

The integrity of a data file that is transmitted from a sender to a receiver is validated. An initial seed is calculated using key material from the sender and the receiver, and random source data. The initial seed is provided to a deterministic random number generator. The deterministic random number generator executes a plurality of times, thereby generating a plurality of random values. A plurality of blocks in the data file is selected as a function of the random values, and a hash value for each of the plurality of blocks is generated. The integrity of the data file is then validated by comparing the hash value for each of the plurality of blocks of the sender to the hash value for each of the plurality of blocks of the receiver.

### TECHNICAL FIELD

Embodiments described herein generally relate to probabilistic signature creation for data files.

### BACKGROUND

When an extremely large file has been transferred to servers or low power devices the cost of the integrity validation of the large file is extremely high. In many cases, it forces the complete abandonment of any integrity and authenticity validations. Examples of very large files include video files, data lakes, archives, images, and disk integrity, wherein efficiency and a quick integrity validation are essential. While complete integrity is desirable, in many cases, having 99.99% or even 99% assurance of the integrity of the file is sufficient. Also, the issue of malware detection is extremely acute when malware is injected into the files and may impact the security of the systems.

Existing solutions to validate the integrity of a file attempt to calculate the complete hash of the whole file or the whole disk. This of course is resource intensive. There are less resource intensive, but less secure, methods of hashing. However, these methods do not have a high strength of security. In cases where there is only an incremental transfer of the data file or a transfer of only changes to the data file, one can attempt to validate only individual chunks or changes to the data file instead of a whole file validation. There are also methods of validation using what is referred to as the fixed span method. However, as is known to those of skill in the art, this method is not recommended for security purposes.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a plurality of data blocks in a data file selected for verification.

FIG. 2 is a block diagram illustrating a data file that has been infected with malware.

FIGS. 3A, 3B, and 3C are a block diagram illustrating operations and features of a system and method to validate the integrity of a data file.

FIG. 4 is a block diagram of a computer architecture that can be used in one or more embodiments of the current disclosure.

### DETAILED DESCRIPTION

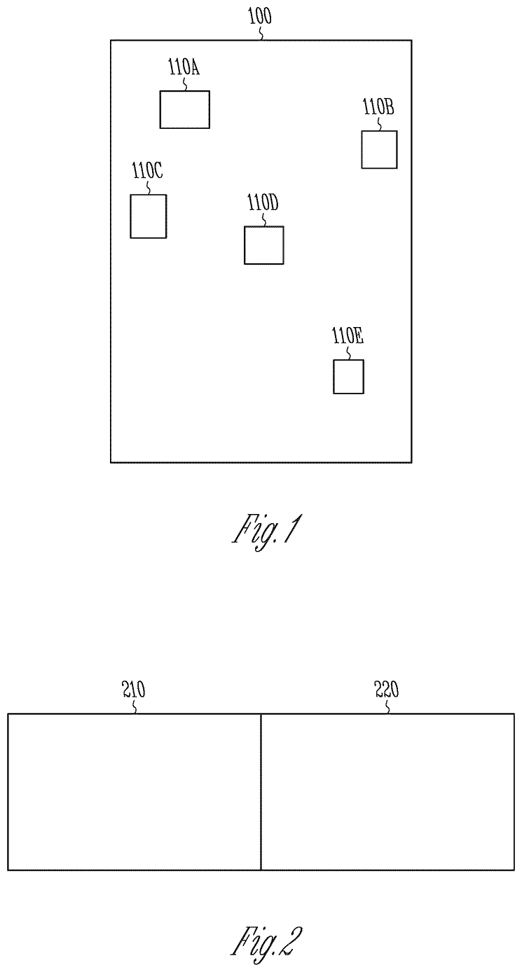

To address the issue of validating the integrity of a data file, and in particular, validating the integrity of a data file in a less resource intensive manner, an embodiment involves a probabilistic method of validation integrity. A map of a block of bytes, or even a map of a plurality of the locations of single bytes, in the file is selected from an initial seed that matches the required strength method. FIG. 1 illustrates an example of such a map 100, which includes blocks 110A, 110B, 110C, 110D and 110E. The initial seed can be derived from a user identity or other authentication attributes, such as a password. These attributes must be unique and not guessable for the file transfer.

When addressing the issue of the validity of the integrity of a data file, one wants to verify that the file that was sent by the sender is the same file that was received by the receiver. That is, no man in the middle (MiTM) inserted anything into the file. As noted in the previous paragraph, this is accomplished by selecting a block of bytes in the file, and then hashing only those selected blocks. As noted, the blocks are randomly selected, and the initial seed can be tied to the identity of the sender and the receiver. The initial seed is agreed upon in advance by the sender and the receiver, or the initial seed is easy to calculate from the file (such as the file size). In an embodiment, the hash generates a single 256-bit value for each selected block.

In an embodiment, a deterministic random bit generator (DRBG) is used. As is known to those of skill in the art, a DRBG will generate the same output for the same input. A DRBG algorithm produces a sequence of bits from an initial value that is determined by the seed. The seed itself can be determined from the output of the randomness source (such as a username and password). Once the seed is provided to the DRBG and the initial value is determined, the DRBG output is predetermined. It is therefore important that the identity seed is unknown to a nefarious MiTM, that is, it is not predictable, not guessable, and not repeatable.

There are many ways to achieve this unpredictability. One way is for the identity seed to be a function of some of the following parameters: the file name, the file size, the sender private key, the receiver public key, the file header, and an initialization vector (IV). An initialization vector is a secure random value that may be included to ensure that the same file from the same source produces a different identity seed on each transfer. The initialization vector, along with some sender identity attributes and the resulting file signature, may have to be sent to the receiver.

In an embodiment, the signature can include the following—sender ID, sender key ID, IV and hash value of blocks from the file. It is noteworthy that both the sender key and the receiver key are included in the calculations. This ensures that there is both authenticity of the source and confidentiality of the identity seed so as to protect against MiTM sniffing. It also prevents guessing of the sampling patterns by a bad actor.

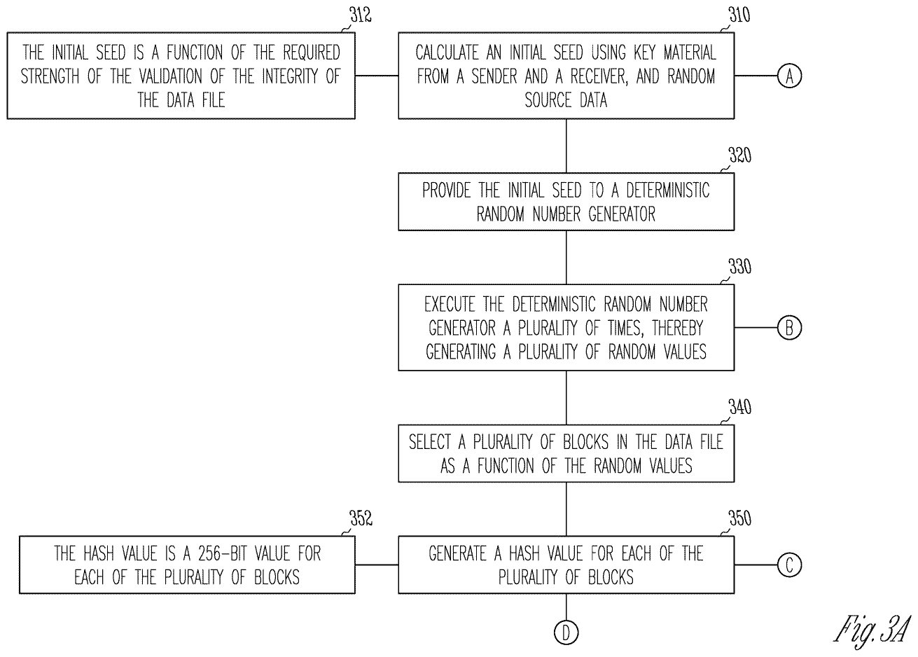

The following is an example of the calculation of a sampling size of the data file that is to be sent from the sender to the receiver. Assuming that there is malware present, in this example, the size of the malware is 100K, and the data file size is 200K. In this situation, the chances of finding malware with a 1-byte check are 50%. That is, as illustrated in FIG. 2, if the malware occupies about half of the total file size, a random one-byte check has an equal chance of selecting a byte from the malware portion of the data file 210 versus selecting a byte from the legitimate portion of the data file 220. With a two-byte check, the chance of the successful identification of the malware increases to 75%, with a three-byte check the chance of success increases to 87.5%, with a four-byte check the chance increases to 93.75%, with a five-byte check the chance increases to 96.87%, and with a ten-byte check the chance increases to 99.9% confidence.

In connection with the disclosed techniques for validating the integrity of a data file, a probability of falsely detecting a compromised file can be determined as follows. Given T=Total file size, M=Modification (e.g., malware) size, and N=size of the sample from the data file, then, the probability of a false negative can be calculated as (1−(M/T))\hat{ }N. For example, if T=1 MB, M=10 KB, and N=459 bytes, the confidence level is 99.00%. That is, there is only a 1% chance of a false positive (falsely detecting a compromised file). Similarly, if N=917 bytes, then the confidence level rises to 99.99%.

In general, there is a safe assumption that the modification size of a piece of malware will most likely exceed 10K in any given file. Using sampling of a small percentage of the actual file as taught in this disclosure, a high detection rate can be achieved, and a high performance can be maintained. If integrity validation for a whole file is required, the methods disclosed herein can be combined with weaker methods, such as using a smaller number of rounds hashing methods, e.g. 8 rounds instead 32. There are also multiple methods of calculating the identity seed, such as those based on a shared secret or other types of key exchange.

In summary, the disclosed embodiments relate to probabilistic methods of integrity validation in which the size of the validated data depends on the file size and the required strength of the validation, and in which the data to be validated are randomly selected. The validation uses a deterministic random function through the locations of the validated data blocks (which can be as small as one byte of data). These blocks are selected via means that are not guessable and are securely random. An identity seed as a derivation function is unknown to any MiTM and cannot be used to determine the areas for data sniffing by bad actors.

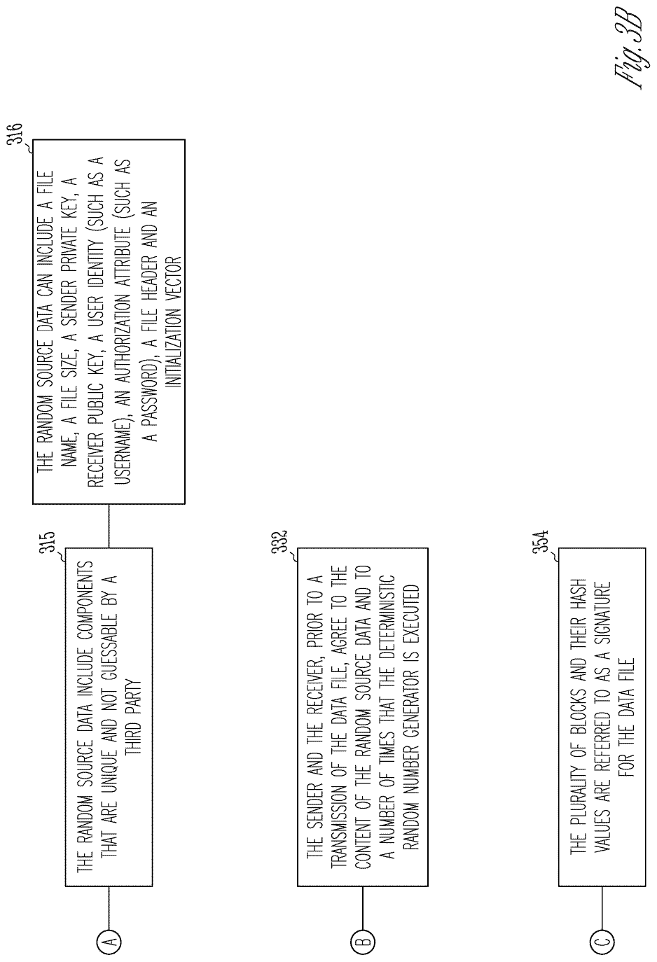

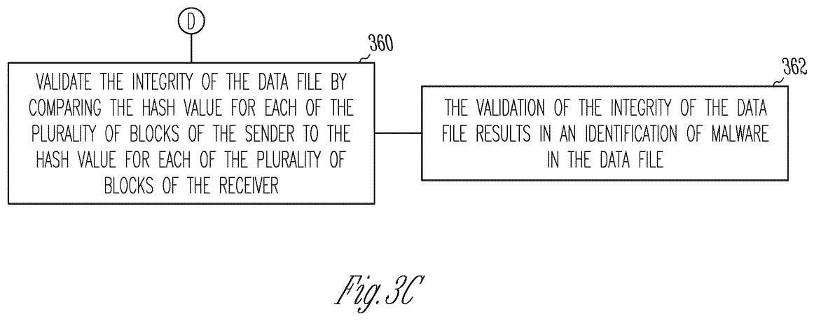

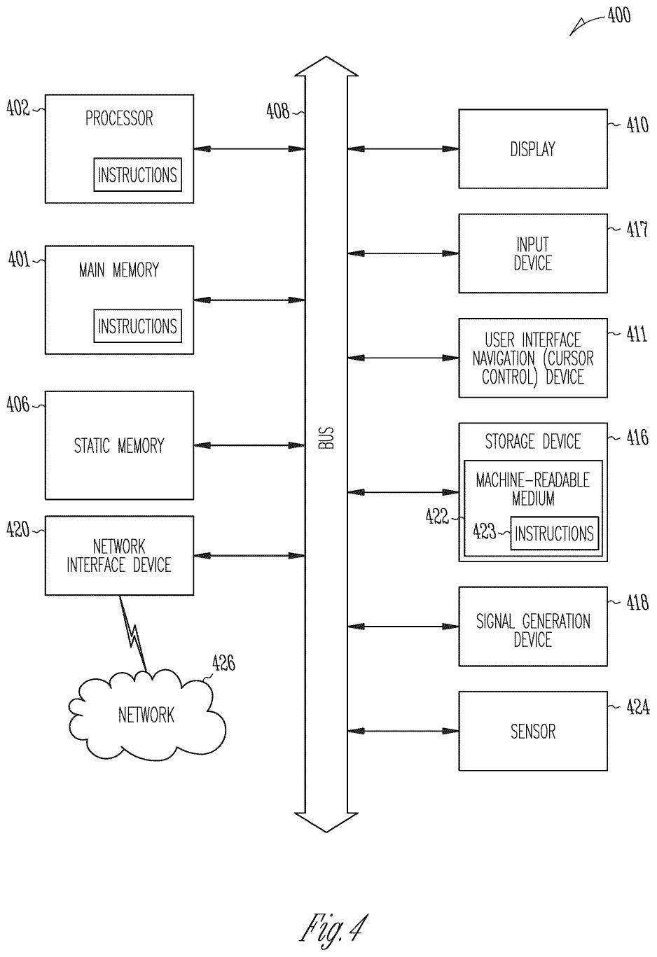

FIGS. 3A, 3B, and 3C are a block diagram illustrating operations and features of a system and method to validate the integrity of a data file that is transmitted from a sender to a receiver. FIGS. 3A, 3B, and 3C include a number of process and feature blocks 310-362. Though arranged substantially serially in the example of FIGS. 3A, 3B, and 3C, other examples may reorder the blocks, omit one or more blocks, and/or execute two or more blocks in parallel using multiple processors or a single processor organized as two or more virtual machines or sub-processors.

Referring now specifically to FIGS. 3A, 3B, and 3C, at 310 an initial seed is calculated using key material from the sender and the receiver, and also random source data. The initial seed is a function of the required strength of the validation of the integrity of the data file (312). That is, the greater the strength of the integrity validation that is needed, the greater the uniqueness of the keys and the random source data needs to be. As indicated at 315, the random source data include one or more components that are unique and not guessable by a third party. For example, as indicated at 316, the random source data can include a file name, a file size, a sender private key, a receiver public key, a user identity (such as a username), an authorization attribute (such as a password), a file header and an initialization vector.

At 320, the initial seed is provided to a deterministic random number generator.

At 330, the deterministic random number generator executes a plurality of times. These executions generate a plurality of random values. As indicated at 332, the sender and the receiver, prior to a transmission of the data file, agree to the content of the random source data and to a number of times that the deterministic random number generator is executed. This agreement assures that the later-calculated hash values for both the sender and receiver will agree, and that the number of blocks that are validated in the sender file and receiver file are the same.

At 340, a plurality of blocks in the data file is selected as a function of the random values. For example, as illustrated in FIG. 1, five random values can be generated, and these random values can serve as or be the basis for the starting locations of the blocks 110A, 110B, 110C, 110D and 110E. It is noted that while they can be virtually any size, the sizes of blocks do not have to be more than a single byte. In general, the disclosed embodiments function just as well with single byte blocks as with blocks with many bytes.

At 350, a hash value is generated for each of the plurality of blocks. The hash value can be a 256-bit value for each of the plurality of blocks (352). The plurality of blocks and their hash values can be referred to as a signature for the data file (354), and as noted above, besides the hash value, the signature can include information based on sender identification, sender key identification, and an initialization vector.

At 360, the integrity of the data file is validated by comparing the hash value for each of the plurality of blocks of the sender to the hash value for each of the plurality of blocks of the receiver. The validation of the integrity of the data file can result in an identification of malware in the data file (362).

The following is an example of high-level code for validating the integrity of a data file.

```
// Sender & Receiver both Generate seed using common values
Seed = KDF(ECDH(fileSize + fileHeader + publicKey))
// Sender & Receiver both Provide seed to number generator
rng = new RandomNumberGenerator(Seed)
// Sender & Receiver both use rng to get random sample points
1stSample = rng.Next( )
2ndSample = rng.Next( )
// Create hash of random samples
partialHash = hash(fileBytes[1stSample] + fileBytes[2ndSample])
// Compare hash to verify integrity
if(partialHash == expectedHash){
  return true;
}
dg = DBRG (Identity seed, file size);
while (i< number of bytes)
{
  position = dg.next( );
  add_hash(.....) , ...
}
```

FIG. 4 is a block diagram illustrating a computing and communications platform 400 in the example form of a general-purpose machine on which some or all the operations of FIGS. 1 and 2 may be carried out according to various embodiments. In certain embodiments, programming of the computing platform 400 according to one or more particular algorithms produces a special-purpose machine upon execution of that programming. In a networked deployment, the computing platform 400 may operate in the capacity of either a server or a client machine in server-client network environments, or it may act as a peer machine in peer-to-peer (or distributed) network environments.

Example computing platform 400 includes at least one processor 402 (e.g., a central processing unit (CPU), a graphics processing unit (GPU) or both, processor cores, compute nodes, etc.), a main memory 401 and a static memory 406, which communicate with each other via a link 408 (e.g., bus). The computing platform 400 may further include a video display unit 410, input devices 417 (e.g., a keyboard, camera, microphone), and a user interface (UI) navigation device 411 (e.g., mouse, touchscreen). The computing platform 400 may additionally include a storage device 416 (e.g., a drive unit), a signal generation device 418 (e.g., a speaker), a sensor 424, and a network interface device 420 coupled to a network 426.

The storage device 416 includes a non-transitory machine-readable medium 422 on which is stored one or more sets of data structures and instructions 423 (e.g., software) embodying or utilized by any one or more of the methodologies or functions described herein. The instructions 423 may also reside, completely or at least partially, within the main memory 401, static memory 406, and/or within the processor 402 during execution thereof by the computing platform 400, with the main memory 401, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 423. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a process for validating the integrity of a data file transmitted from a sender to a receiver comprising calculating an initial seed using key material from the sender and the receiver, and random source data; providing the initial seed to a deterministic random number generator; executing the deterministic random number generator a plurality of times, thereby generating a plurality of random values; selecting a plurality of blocks in the data file as a function of the random values; generating a hash value for each of the plurality of blocks; and validating the integrity of the data file by comparing the hash value for each of the plurality of blocks of the sender to the hash value for each of the plurality of blocks of the receiver.

Example No. 2 includes the features of Example No. 1 and optionally includes a process wherein the random source data comprise one or more components that are unique and not guessable by a third party.

Example No. 3 includes the features of Example Nos. 1-2 and optionally includes a process wherein the random source data comprise one or more of a file name, a file size, a sender private key, a receiver public key, a file header and an initialization vector.

Example No. 4 includes the features of Example Nos. 1-3 and optionally includes a process wherein the random source data comprise a user identity and a user authorization attribute.

Example No. 5 includes the features of Example Nos. 1-4 and optionally includes a process wherein the initial seed comprises a function of a required strength of the validation of the integrity of the data file.

Example No. 6 includes the features of Example Nos. 1-5 and optionally includes a process wherein validating the integrity of the data file results in an identification of malware in the data file.

Example No. 7 includes the features of Example Nos. 1-6 and optionally includes a process comprising forming a signature for the data file, the signature comprising the hash value, a sender identification, a sender key identification, and an initialization vector.

Example No. 8 includes the features of Example Nos. 1-7 and optionally includes a process wherein the sender and the receiver, prior to a transmission of the data file, agree to a content of the random source data and to a number of times that the deterministic random number generator is executed.

Example No. 9 includes the features of Example Nos. 1-8 and optionally includes a process wherein the hash value comprises a 256-bit value for each of the plurality of blocks.

Example No. 10 includes the features of Example Nos. 1-9 and optionally includes a process wherein locations of the blocks in the data file are a function of the random values.

Example No. 11 is a machine-readable medium comprising instructions that when executed by a processor execute a process comprising calculating an initial seed using key material from the sender and the receiver, and random source data: providing the initial seed to a deterministic random number generator; executing the deterministic random number generator a plurality of times, thereby generating a plurality of random values; selecting a plurality of blocks in the data file as a function of the random values; generating a hash value for each of the plurality of blocks; and validating the integrity of the data file by comparing the hash value for each of the plurality of blocks of the sender to the hash value for each of the plurality of blocks of the receiver.

Example No. 12 includes the features of Example No. 11, and optionally includes a machine-readable medium wherein the random source data comprise one or more components that are unique and not guessable by a third party.

Example No. 13 includes the features of Example Nos. 11-12 and optionally includes a machine-readable medium wherein the random source data comprise one or more of a file name, a file size, a sender private key, a receiver public key, a file header and an initialization vector.

Example No. 14 includes the features of Example Nos. 11-13 and optionally includes a machine-readable medium wherein the random source data comprise a user identity and a user authorization attribute.

Example No. 15 includes the features of Example Nos. 11-14 and optionally includes a machine-readable medium wherein the initial seed comprises a function of a required strength of the validation of the integrity of the data file.

Example No. 16 includes the features of Example Nos. 11-15 and optionally includes a machine-readable medium wherein validating the integrity of the data file results in an identification of malware in the data file.

Example No. 17 includes the features of Example Nos. 11-16 and optionally includes a machine-readable medium comprising instructions for forming a signature for the data file, the signature comprising the hash value, a sender identification, a sender key identification, and an initialization vector.

Example No. 18 includes the features of Example Nos. 11-17 and optionally includes a machine-readable medium wherein the sender and the receiver, prior to a transmission of the data file, agree to a content of the random source data and to a number of times that the deterministic random number generator is executed.

Example No. 19 includes the features of Example Nos. 11-18 and optionally includes a machine-readable medium wherein locations of the blocks in the data file are a function of the random values.

Example No. 20 is a system comprising a processor and a memory coupled to the computer processor; wherein the processor and the memory are operable for calculating an initial seed using key material from the sender and the receiver, and random source data; providing the initial seed to a deterministic random number generator; executing the deterministic random number generator a plurality of times, thereby generating a plurality of random values; selecting a plurality of blocks in the data file as a function of the random values; generating a hash value for each of the plurality of blocks; and validating the integrity of the data file by comparing the hash value for each of the plurality of blocks of the sender to the hash value for each of the plurality of blocks of the receiver.

1. A process for validating integrity of a data file transmitted from a sender to a receiver comprising:
calculating an initial seed using material from the sender and the receiver, and random source data;
providing the initial seed to a deterministic random number generator;
executing the deterministic random number generator a plurality of times, thereby generating a plurality of random values;
selecting a plurality of blocks in the data file as a function of the random values;
generating a hash value for each of the plurality of blocks; and
validating the integrity of the data file by comparing the hash value for each of the plurality of blocks of the sender to the hash value for each of the plurality of blocks of the receiver.

2. The process of claim 1, wherein the random source data comprise one or more components that are unique and not guessable by a third party.

3. The process of claim 2, wherein the random source data comprise one or more of a file name, a file size, a sender private key, a receiver public key, a file header and an initialization vector.

4. The process of claim 2, wherein the random source data comprise a user identity and a user authorization attribute.

5. The process of claim 1, wherein the initial seed comprises a function of a required strength of the validation of the integrity of the data file.

6. The process of claim 1, wherein validating the integrity of the data file results in an identification of malware in the data file.

7. The process of claim 1, comprising forming a signature for the data file, the signature comprising the hash value, a sender identification, a sender key identification, and an initialization vector.

8. The process of claim 1, wherein the sender and the receiver, prior to a transmission of the data file, agree to a content of the random source data and to a number of times that the deterministic random number generator is executed.

9. The process of claim 1, wherein the hash value comprises a 256-bit value for each of the plurality of blocks.

10. A non-transitory machine-readable medium comprising instructions that when executed by a processor execute a process comprising:
calculating an initial seed using material from the sender and the receiver, and random source data;
providing the initial seed to a deterministic random number generator;
executing the deterministic random number generator a plurality of times, thereby generating a plurality of random values;
selecting a plurality of blocks in the data file as a function of the random values;
generating a hash value for each of the plurality of blocks; and
validating the integrity of the data file by comparing the hash value for each of the plurality of blocks of the sender to the hash value for each of the plurality of blocks of the receiver.

11. The non-transitory machine-readable medium of claim 10, wherein the random source data comprise one or more components that are unique and not guessable by a third party.

12. The non-transitory machine-readable medium of claim 11, wherein the random source data comprise one or more of a file name, a file size, a sender private key, a receiver public key, a file header and an initialization vector.

13. The non-transitory machine-readable medium of claim 11, wherein the random source data comprise a user identity and a user authorization attribute.

14. The non-transitory machine-readable medium of claim 10, wherein the initial seed comprises a function of a required strength of the validation of the integrity of the data file.

15. The non-transitory machine-readable medium of claim 10, wherein validating the integrity of the data file results in an identification of malware in the data file.

16. The non-transitory machine-readable medium of claim 10, comprising forming a signature for the data file, the signature comprising the hash value, a sender identification, a sender key identification, and an initialization vector.

17. The non-transitory machine-readable medium of claim 10, wherein the sender and the receiver, prior to a transmission of the data file, agree to a content of the random source data and to a number of times that the deterministic random number generator is executed.

18. The non-transitory machine-readable medium of claim 10, wherein locations of the blocks in the data file are a function of the random values.

19. A system comprising:
a processor; and
a memory coupled to the computer processor;
wherein the processor and the memory are operable for:
calculating an initial seed using material from the sender and the receiver, and random source data;
providing the initial seed to a deterministic random number generator;
executing the deterministic random number generator a plurality of times, thereby generating a plurality of random values;
selecting a plurality of blocks in the data file as a function of the random values;
generating a hash value for each of the plurality of blocks; and
validating the integrity of the data file by comparing the hash value for each of the plurality of blocks of the sender to the hash value for each of the plurality of blocks of the receiver.

20. The system of claim 19, wherein validating the integrity of the data file results in an identification of malware in the data file.
